(19) United States
(12) Patent Application Publication
(10) Pub. No.: US 2025/0227094 A1
(43) Pub. Date: Jul. 10, 2025

(54) APPARATUS AND METHOD WITH HOMOMORPHIC ENCRYPTION

(71) Applicants: Samsung Electronics Co., Ltd., Suwon-si (KR); Chung Ang University Industry Academic Cooperation Foundation, Seoul (KR)

(72) Inventors: Joon Woo LEE, Seoul (KR); Byeong Seo MIN, Seoul (KR); Seom kyun SONG, Seoul (KR)

(73) Assignees: Samsung Electronics Co., Ltd., Suwon-si (KR); Chung Ang University Industry Academic Cooperation Foundation, Seoul (KR)

(21) Appl. No.: 18/974,105

(22) Filed: Dec. 9, 2024

(30) Foreign Application Priority Data
Jan. 9, 2024 (KR) 10-2024-0003754

(51) Int. Cl. H04L 9/40

(52) U.S. Cl. CPC H04L 63/0428

(57) ABSTRACT

A processor-implemented method including generating packing data of encrypted input data, based on a packing constant and a duplication constant, generating an operation result set based on a homomorphic encryption operation for a convolution operation on each of kernels belonging to a same group in the kernel set and the packing data, and generating a convolution operation result of the encrypted input data based on a rotation operation of operation result sets generated corresponding to groups in the kernel set.

### CROSS-REFERENCE TO RELATED APPLICATIONS

This application claims the benefit under 35 USC § 119 (a) of Korean Patent Application No. 10-2024-0003754, filed on Jan. 9, 2024, in the Korean Intellectual Property Office, the entire disclosure of which is incorporated herein by reference for all purposes.

### BACKGROUND

### 1. Field

The following description relates to an apparatus and method with homomorphic encryption.

### 2. Description of Related Art

Homomorphic encryption is an encryption method that enables arbitrary operations between pieces of encrypted data. The use of homomorphic encryption enables arbitrary operations on encrypted data without decrypting the encrypted data. In addition, because homomorphic encryption is lattice-based, homomorphic encryption is there resistant to quantum algorithms and considered safely encrypted. To reduce the total operation time in approximate isomorphic encryption, it is necessary to pack as much data as possible in one ciphertext and perform one operation at a time. In addition, it is necessary to reduce the number of rotation operations during a convolution operation on a ciphertext.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating packing data of encrypted input data, based on a packing constant and a duplication constant, generating an operation result set based on a homomorphic encryption operation for a convolution operation on each of kernels belonging to a same group in the kernel set and the packing data, and generating a convolution operation result of the encrypted input data based on a rotation operation of operation result sets generated corresponding to groups in the kernel set.

The generating of the packing data of the encrypted input data may include duplicating the encrypted input data according to the duplication constant and generating the packing data of the encrypted input data by arranging the duplicated encrypted input data for each channel based on the packing constant.

An operation result set corresponding to one group in the kernel set may be generated based on a rotation operation in a same rotation direction.

The generating of the operation result set may include generating an elementwise product result of each of the kernels belonging to a same group in the kernel set and the packing data, performing a rotation operation and an addition operation on the elementwise product result, and generating the operation result set by extracting a valid value from a result of the rotation operation and the addition operation.

The generating of the operation result set further may include generating, among the result of the rotation operation and the addition operation, the operation result set by multiplying the valid value by 0 and remaining values by 1.

The kernels belonging to the same group in the kernel set may be determined based on a disposition of the convolution operation result.

The homomorphic encryption operation may include a multiplication operation, an addition operation, and a rotation operation for the convolution operation.

The generating of the operation result set may include selecting an operation of a hoisting operation and a rotation operation based on a number of pieces of data to be summed for the convolution operation and generating the operation result set based on the selected operation.

The selecting of the operation may include selecting the operation of the hoisting operation and the rotation operation based on the number of pieces of data to be summed for the convolution operation and based on a comparison result of an operation time of a predicted hoisting operation and an operation time of a predicted rotation operation.

The encrypted input data may be configured to encode input data into a one-dimensional vector and the encrypted input data may be generated by encrypting the encoded one-dimensional vector.

In a general aspect, here is provided an electronic apparatus including a processor configured to generate packing data of encrypted input data, based on a packing constant and a duplication constant, generate an operation result set based on a homomorphic encryption operation for a convolution operation on each of kernels belonging to a same group in a kernel set and the packing data, and generate a convolution operation result of the encrypted input data based on a rotation operation of operation result sets generated corresponding to groups in the kernel set.

The apparatus may include a receiver configured to receive the encrypted input data and the kernel set.

In response to the generating of the packing data of the encrypted input data, the processor may be configured to duplicate the encrypted input data according to the duplication constant and generate the packing data of the encrypted input data by arranging the duplicated encrypted input data for each channel based on the packing constant.

The processor may be configured to generate an operation result set corresponding to one group in the kernel set based on a rotation operation in a same rotation direction.

In response to the generating of the operation result set, the processor may be configured to generate an elementwise product result of each of the kernels belonging to a same group in the kernel set and the packing data, perform a rotation operation and an addition operation on the elementwise product result, and generate the operation result set by extracting a valid value from a result of the rotation operation and the addition operation.

In response to the generating of the operation result set, the processor may be configured to obtain, among the result of the rotation operation and the addition operation, the operation result set by multiplying the valid value by 0 and the remaining values by 1.

The processor may be configured to determine kernels belonging to the same group in the kernel set based on a disposition of the convolution operation result.

The homomorphic encryption operation may include a multiplication operation, an addition operation, and a rotation operation for the convolution operation.

In response to the generating of the operation result set, the processor may be configured to select an operation of a hoisting operation and a rotation operation based on a number of pieces of data to be summed for the convolution operation and generate the operation result set based on the selected operation.

In response to the selecting of the operation of the hoisting operation and the rotation operation, the processor may be configured to select the operation of the hoisting operation and the rotation operation based on the number of pieces of data to be summed for the convolution operation and based on a comparison result of an operation time of a predicted hoisting operation and an operation time of a predicted rotation operation.

### BRIEF DESCRIPTION OF THE DRAWINGS

FIG. 1 illustrates an example electronic apparatus according to one or more embodiments.

FIG. 2 illustrates an example homomorphic encryption operation method according to one or more embodiments.

FIG. 3 illustrates an example homomorphic encryption operation method according to one or more embodiments.

FIG. 4 illustrates an example of packing data according to one or more embodiments.

FIG. 5 illustrates an example data display method according to one or more embodiments.

FIG. 6 illustrates an example data display method according to one or more embodiments.

FIG. 7 illustrates an example operation of generating an elementwise product result of each of kernels belonging to the same group in a kernel set and packing data according to one or more embodiments.

FIG. 8 illustrates an example operation of generating an operation result set according to one or more embodiments.

FIG. 9 illustrates an example operation of generating an operation result set according to one or more embodiments.

FIG. 10 illustrates an example operation of generating a convolution operation result according to one or more embodiments.

FIG. 11 illustrates an example homomorphic encryption operation process for generating a convolution operation result according to one or more embodiments.

FIG. 12 illustrates an example homomorphic encryption operation process for generating a convolution operation result according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

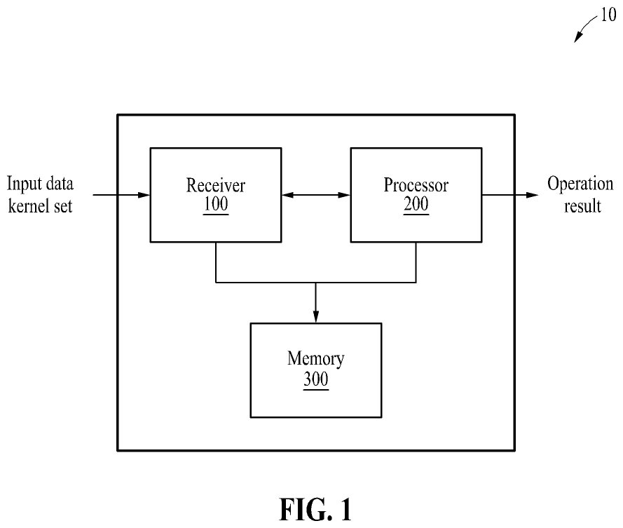

FIG. 1 illustrates an example electronic apparatus according to one or more embodiments.

Referring to FIG. 1, in a non-limiting example, an electronic apparatus 10 may perform a homomorphic encryption operation. The electronic apparatus 10 may perform the homomorphic encryption operation using a neural network. The homomorphic encryption operation may include a convolution operation, down sampling operation, or average pooling operation.

In an example, homomorphic encryption may refer to a method of encryption configured to allow various operations to be performed on data as being encrypted. In homomorphic encryption, the result of an operation using ciphertexts may become a new ciphertext, and a plaintext obtained by decrypting the ciphertext may be the same as an operation result of the original data before the encryption.

Hereinafter, encrypted data or encrypted text may be referred to as a ciphertext.

The neural network may generally refer to a model having a problem-solving ability implemented through artificial neurons or nodes forming a network through synaptic connections where the strength of the synaptic connections changes through training.

A neuron of the neural network may include a combination of weights or biases. The neural network may include one or more layers each including one or more neurons or nodes. The neural network may infer a result from a predetermined input by changing weights of the neurons through training.

In an example, the neural network may include a deep neural network (DNN). The neural network may include a convolutional neural network (CNN), recurrent neural network (RNN), perceptron, multiplayer perceptron, feed forward (FF), radial basis network (RBF), deep feed forward (DFF), long short-term memory (LSTM), gated recurrent unit (GRU), auto encoder (AE), variational auto encoder (VAE), denoising auto encoder (DAE), sparse auto encoder (SAE), Markov chain (MC), Hopfield network (HN), Boltzmann machine (BM), restricted Boltzmann machine (RBM), deep belief network (DBN), deep convolutional network (DCN), deconvolutional network (DN), deep convolutional inverse graphics network (DCIGN), generative adversarial network (GAN), liquid state machine (LSM), extreme learning machine (ELM), echo state network (ESN), deep residual network (DRN), differentiable neural computer (DNC), neural turning machine (NTM), capsule network (CN), Kohonen network (KN), and attention network (AN).

The electronic apparatus 10 may be implemented in a personal computer (PC), data server, or portable device.

The portable device may be implemented as, for example, a laptop computer, mobile phone, smartphone, tablet PC, mobile internet device (MID), personal digital assistant (PDA), enterprise digital assistant (EDA), digital still camera, digital video camera, portable multimedia player (PMP), personal or portable navigation device (PND), handheld game console, e-book, or smart device. The smart device may be implemented as, for example, a smartwatch, smart band, or smart ring.

The electronic apparatus 10 may include a receiver 100 and a processor 200. The electronic apparatus 10 may further include a memory 300.

The receiver 100 may include a receiving interface. The receiver 100 may receive data for the homomorphic encryption operation. The receiver 100 may receive encrypted input data for performing a homomorphic encryption operation and a kernel set for performing an operation on the encrypted input data. The receiver 100 may output the received encrypted input data and the kernel set to the processor 200.

The processor 200 may process data stored in the memory 300. The processor 200 may execute computer-readable code (e.g., software) stored in the memory 300 and instructions triggered by the processor 200.

The processor 200 may further execute programs, and/or may control the electronic apparatus 10, and may include any one or a combination of two or more of, for example, a central processing unit (CPU), a graphic processing unit (GPU), a neural processing unit (NPU) and tensor processing units (TPUs), but is not limited to the above-described examples.

The processor 200 may be a data-processing device implemented by hardware having a circuit of a physical structure to execute desired operations. For example, the desired operations may include code or instructions in a program.

The hardware-implemented data-processing device may include, for example, a microprocessor, a CPU, a processor core, a multi-core processor, a multiprocessor, an application-specific integrated circuit (ASIC), and a field-programmable gate array (FPGA).

The memory 300 may include computer-readable instructions. The processor 200 may be configured to execute computer-readable instructions, such as those stored in the memory 300, and through execution of the computer-readable instructions, the processor 200 is configured to perform one or more, or any combination, of the operations and/or methods described herein. The memory 300 may be a volatile or nonvolatile memory.

The processor 200 may perform at least one operation included in a homomorphic encryption operation method. For example, the processor 200 may perform at least one of receiving encrypted input data for performing a homomorphic encryption operation and a kernel set for performing an operation on the encrypted input data, generating packing data of the encrypted input data, based on a packing constant and a duplication constant, generating an operation result set based on the homomorphic encryption operation for a convolution operation of each of kernels belonging to the same group in the kernel set and the packing data, and generating a convolution operation result of the encrypted input data based on a rotation operation of operation result sets obtained, or generated, corresponding to groups in the kernel set. The homomorphic encryption operation method is described below.

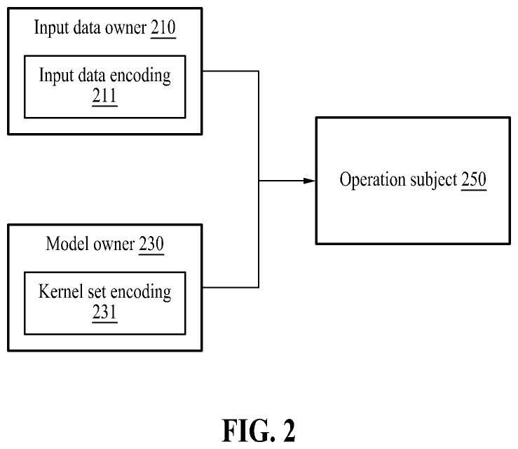

FIG. 2 illustrates an example homomorphic encryption operation method according to one or more embodiments.

Referring to FIG. 2, in a non-limiting example, a processor (e.g., the processor 200 of FIG. 1) may include an input data owner 210, a model owner 230, and an operation subject 250. The input data owner 210, the model owner 230, and the operation subject 250 may be implemented by one or more pieces of hardware and/or different pieces of hardware.

In an example, the input data owner 210 may generate an operation subject on which a homomorphic encryption operation is performed and may output the operation subject as the operation subject 250. Input data may include an image or feature map obtained, or generated, by an output of a previous layer. The input data owner 210 may generate encrypted input data and may output the encrypted input data as the operation subject 250.

The input data owner 210 may perform input data encoding 211. The input data encoding 211 may refer to a process of encrypting the input data and converting the encrypted input data into a one-dimensional vector. The input data owner 210 may perform encryption on the input data. The input data owner 210 may map a vector [symbol] ^{N/2} to a ring element R= [symbol] [X]/(X^{N}+1) The input data owner 210 may encrypt the ring element R= [symbol] [X]/(X^{N}+1) into an actual ciphertext ct∈R_{Q}_{_{L}}²(R_{Q}_{_{L}}= [symbol] _{Q}_{_{L}}[X]/(X^{N}+1)) Through encryption, the input data owner 210 may make it impossible for a person who does not own a secret key to know the corresponding plaintext data or information about an encoded R element through a ciphertext.

The input data encoding 211 may include generating packing data of the encrypted input data. The input data encoding 211 is described below.

In an example, the model owner 230 may output a kernel set for a homomorphic encryption operation as the operation subject 250. The kernel set may include one or more kernels corresponding to at least one layer included in a neural network. A kernel may include one or more weight (or weight) values determined by training of the neural network.

The model owner 230 may perform kernel set encoding 231. The kernel set encoding 231 may refer to a process of encrypting the kernel set and converting the encrypted kernel set into a one-dimensional vector. In an example, the model owner 230 may determine whether a model needs to be protected and may perform encryption on the kernel set when it is determined that the model needs to be protected.

The operation subject 250 may perform a homomorphic encryption operation, based on the encrypted input data and the kernel set (or the encrypted kernel set). In an example, the operation subject 250 may perform a homomorphic encryption operation for a convolution operation on the encrypted input data and the kernel set (or the encrypted kernel set). In an example, the homomorphic encryption operation for the convolution operation may include a multiplication operation, addition operation, and rotation operation for the convolution operation. A method of the homomorphic encryption operation for the convolution operation is described in detail below.

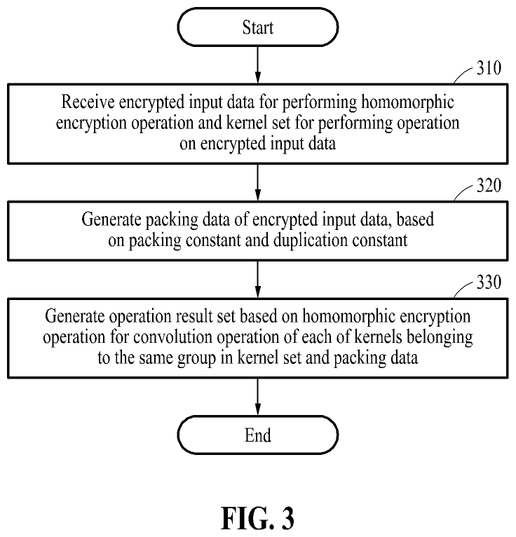

FIG. 3 illustrates an example homomorphic encryption operation method according to one or more embodiments.

Referring to FIG. 3, in a non-limiting example, a homomorphic encryption operation method may include operation 310 of receiving encrypted input data for performing a homomorphic encryption operation and a kernel set for performing an operation on the encrypted input data.

In an example, the kernel set for performing an operation on the encrypted input data may include an unencrypted kernel set or encrypted kernel set. Encryption of the kernel set may be performed based on a homomorphic encryption method. The kernel set may be encoded into a one-dimensional vector. The encrypted input data may be generated by encoding input data into a one-dimensional vector and encrypting the encoded one-dimensional vector.

The homomorphic encryption operation method may include operation 320 of generating packing data of the encrypted input data, based on a packing constant and a duplication constant. The packing constant and the duplication constant may include any predetermined constant.

In an example, operation 320 of generating the packing data of the encrypted input data may include duplicating the encrypted input data a plurality of times based on the duplication constant and generating the packing data of the encrypted input data by arranging the duplicated encrypted input data for each channel based on the packing constant. Hereinafter, the input data may refer to the encrypted input data.

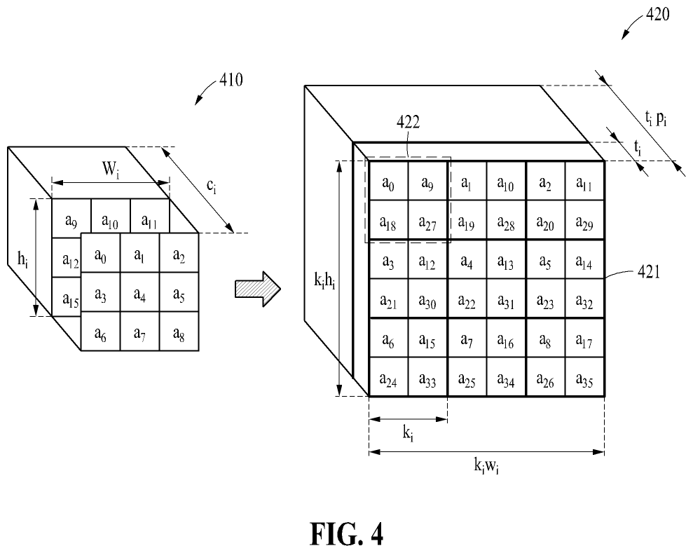

FIG. 4 illustrates an example of packing data according to one or more embodiments.

Referring to FIG. 4, in a non-limiting example, packing data of input data is illustrated having a packing constant kᵢ is 2. The packing constant kᵢ may be a constant indicating that pieces of data belonging to the same channel are distributed apart at an interval of several slots. The packing constant kᵢ of 2 may indicate that the pieces of data belonging to the same channel are distributed at an interval of 2 slots.

In an example, input data 410 may be data of a dimension corresponding to a height hᵢ of 3, width wᵢ of 3, and cᵢ channels. Referring to packing data 420 of the input data 410, when the packing constant kᵢ is 2, data a₀ and data a₂ belonging to the same channel may be located at an interval of 2 slots. A channel 421 of the packing data 420 may correspond to data in which pieces of data of a first channel, second channel, third channel, and fourth channel of the input data 410 are disposed at an interval of 2 slots. When the channel 421 of the packing data 420 is divided into a block including 2×2 slots, a block 422 corresponding to row 1 and column 1 of the channel 421 may include the data a₀ located in row 1 and column 1 of the first channel of the input data 410, data ag located in row 1 and column 1 of the second channel of the input data 410, data a₁₈ located in row 1 and column 1 of the third channel of the input data 410, and data a₂₇ located in row 1 and column 1 of the fourth channel of the input data 410.

A dimension of the packing data 420 may be determined based on a dimension of the input data 410, the packing constant kᵢ, and a duplication constant pᵢ. The duplication constant pᵢ is the number of same pieces of input data 410 included in the packing data 420 and may include two sets of packed input data when the duplication constant pᵢ is, for example, 2. The height of the packing data 420 may be determined to be hᵢ×kᵢ, which is a product of the height hᵢ of the input data 410 and the packing constant kᵢ, the width of the packing data 420 may be determined to be wᵢ×kᵢ, which is a product of the width wᵢ of the packing data 420 and the packing constant kᵢ, and the number of channels of the packing data 420 may be determined to be tᵢ×pᵢ and may also be determined to be

$${t}_{i} = ⌈ \frac{{c}_{i}}{{k}_{i}^{2}} ⌉ .$$

For ease of description, although FIG. 4 illustrates the packing data 420 as three-dimensional (3D) data, the packing data 420 may be, in an example, data corresponding to a one-dimensional vector. In an example, data included in the channel 421 in two dimensions may correspond to a one-dimensional vector in the form in which an arrangement list of data included in row 2 is connected after an arrangement of data included in row 1, and an arrangement of data included in row 3 is connected after an arrangement of data included in row 2. In addition, the packing data 420 may correspond to a one-dimensional vector in the form in which an arrangement of data included in the second channel is connected after an arrangement of data included in the first channel.

In an example, the homomorphic encryption operation method may include operation 330 of obtaining, or generating, an operation result set based on a homomorphic encryption operation for a convolution operation of each of kernels belonging to the same group in a kernel set and packing data.

The number of kernels belonging to the same group in the kernel set may correspond to a duplication constant for determining the packing data. In an example, when the number of kernels belonging to the same group in the kernel set is 2, the duplication constant may be 2 and the packing data may include two sets of packed input data. The convolution operation may be performed on each kernel belonging to the same group in the kernel set and a set of packed input data included in the packing data. The operation result set may include a convolution operation result of each kernel belonging to the same group in the kernel set and a set of the packed input data included in the packing data.

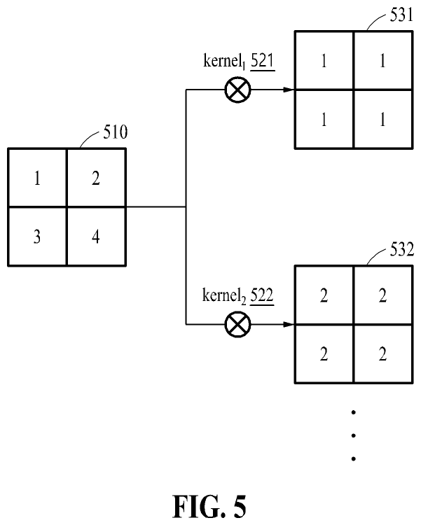

As described below in greater detail with respect to FIGS. 5 to 13, the channel 421 in which the pieces of data of the first channel, second channel, third channel, and fourth channel included in the packing data 420 of FIG. 4 are disposed at an interval of 2 slots may be simply expressed as a data display 510 shown in FIG. 5.

FIG. 5 illustrates an example data display method according to one or more embodiment.

That is, referring to FIG. 5, in a non-limiting example, the data display 510 may refer to a set of packed input data corresponding to the first channel, second channel, third channel, and fourth channel of input data. An elementwise product result of a portion of packing data and a first kernel kernel₁ 521 may be simply expressed as a data display 531 as illustrated in FIG. 5. An elementwise product result of a portion of packing data and a second kernel kernel₂ 522 may be simply expressed as a data display 532 shown in FIG. 5.

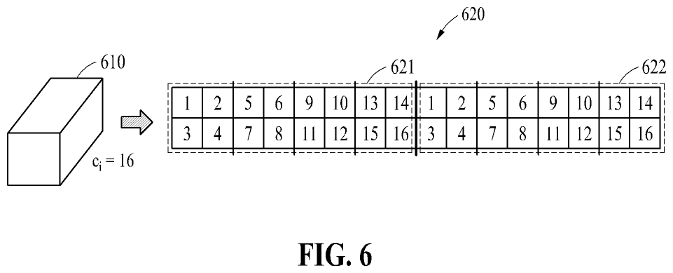

FIG. 6 illustrates an example data display method according to one or more embodiments.

Referring to FIG. 6, in a non-limiting example, the entire packing data corresponding to duplication constant 2 of input data 610 of 16 channels may be expressed as a data display 620 by applying the data display methods described above with reference to FIG. 5 to the entire packing data. A set of packed input data indicated by a data display 621 may be the same as the other set of packed input data indicated by a data display 622. Hereinafter, a homomorphic encryption operation process for a convolution operation is described when the size of a channel of input data is 16, a kernel set includes 32 kernels, and kernels included in the kernel set are classified into a group in which the nth kernel and the n+8 kernel (i.e., n=1, 2, . . . , 24) are the same based on a disposition of a convolution operation result.

Referring back to FIG. 3, in an example, operation 330 of obtaining the operation result set may include generating an elementwise product result of each of the kernels belonging to the same group in the kernel set and the packing data, performing a rotation operation and an addition operation on the elementwise product result, and generating the operation result set by extracting a valid value from a result of the rotation operation and the addition operation. In an example, operation 330 of obtaining the operation result set may include generating the operation result set by multiplying the valid value of the result of the rotation operation and the addition operation by 0 and the remaining values by 1.

In an example, the kernels included in the kernel set may be classified into one or more groups. The kernels belonging to the same group in the kernel set may be determined based on a disposition of a convolution operation result. In an example, the kernels belonging to the same group in the kernel set may be determined based on a rotation direction according to the disposition of the convolution operation result. That is, kernels on which a rotation operation in the same rotation direction must be performed to be disposed in the convolution operation result may be classified into the same group. An operation result set corresponding to one group in the kernel set may be obtained, or generated, based on the rotation operation in the same rotation direction.

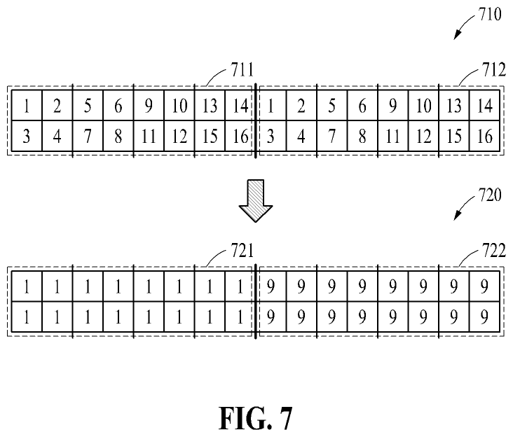

FIG. 7 illustrates an example operation of generating an elementwise product result of each of kernels belonging to the same group in a kernel set and packing data according to one or more embodiments.

Referring to FIG. 7, in a non-limiting example, when a first kernel and a ninth kernel belong to the same group in a kernel set, a convolution operation may be performed on a set of packed input data 711 included in packing data 710 with the first kernel, and a convolution operation may be performed on the other set of packed input data 712 with the ninth kernel. An intermediate operation result 720 including an elementwise product result 721 of a set of the packed input data 711 included in the packing data 710 with the first kernel and an elementwise product result 722 of the other set of the packed input data 712 with the ninth kernel may be obtained.

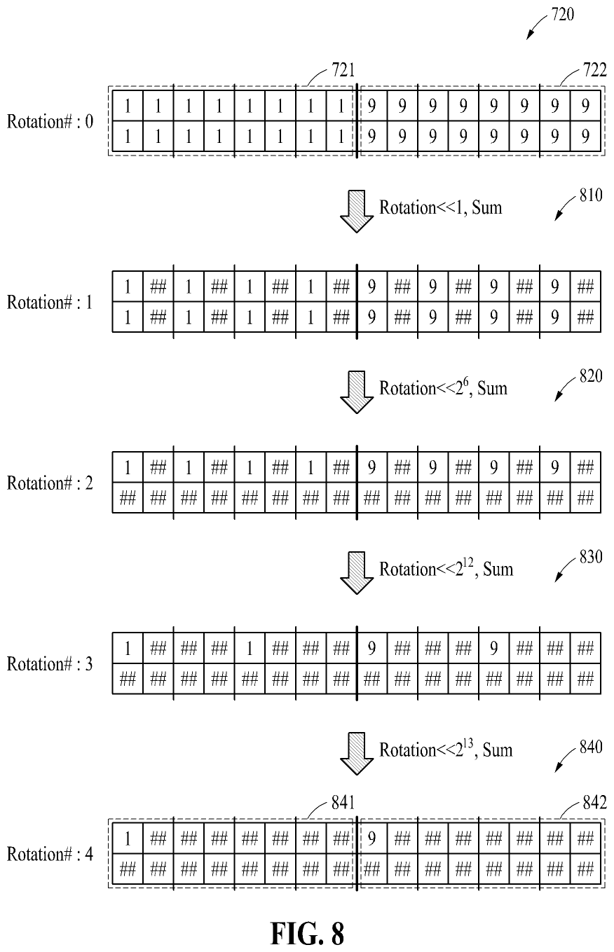

FIG. 8 illustrates an example operation of generating an operation result set according to one or more embodiments.

Referring to FIG. 8, in a non-limiting example, a rotation operation and an addition operation may be performed to sum elementwise product results corresponding to each channel for each kernel included in the intermediate operation result 720. In FIGS. 8 to 13, a display ‘##’ may refer to an invalid value. Elementwise product results of different kernels may be simultaneously summed using the rotation operation and the addition operation in the same direction. As a result of performing a first rotation operation and addition operation, a result 810 generated by summing elementwise product results of a first kernel and a ninth kernel corresponding to two channels may be obtained. As a result of performing a second rotation operation and addition operation, a result 820 generated by summing elementwise product results of the first kernel and the ninth kernel corresponding to four channels may be obtained. As a result of performing a third rotation operation and addition operation, a result 830 generated by summing elementwise product results of the first kernel and the ninth kernel corresponding to eight channels may be obtained. As a result of performing a fourth rotation operation and addition operation, an operation result set 840 corresponding to the first kernel and the ninth kernel including a result 841 generated by summing elementwise product results of the first kernel for each channel and a result 842 generated by summing elementwise product results of the ninth kernel for each channel may be obtained.

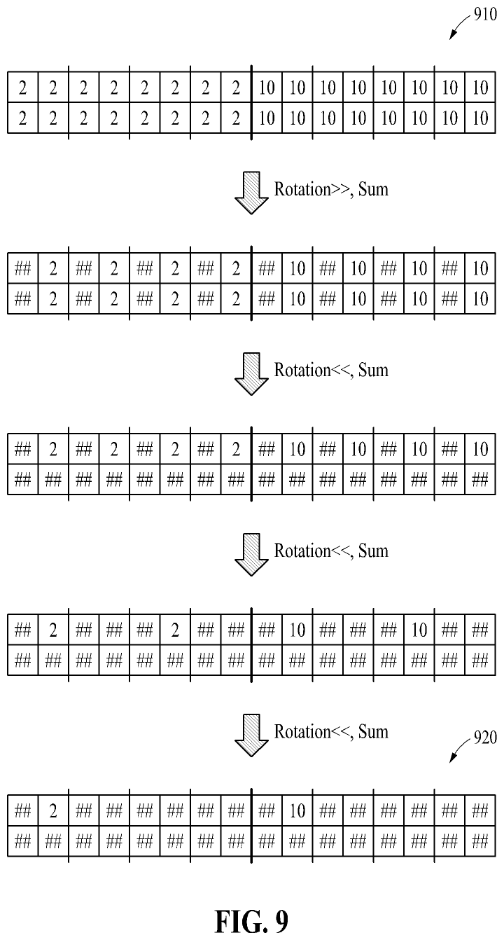

FIG. 9 illustrates an example operation of generating an operation result set according to one or more embodiments.

Referring to FIG. 9, in a non-limiting example, a process of a rotation operation and an addition operation for summing elementwise product results 910 of a second kernel and a tenth kernel belonging to the same group is illustrated. Unlike the process of summing the elementwise product results 720 of the first channel and the ninth channel shown in FIG. 8, a first rotation operation may be performed in a negative direction to sum the elementwise product results 910 of the second channel and a tenth channel. As a result of performing a fourth rotation operation and addition operation, an operation result set 920 corresponding to the second kernel and the tenth kernel may be obtained, or generated. In this way, a plurality of operation result sets corresponding to all kernels belonging to the same group in the kernel set may be obtained.

Referring back to FIG. 3, in a non-limiting example, the homomorphic encryption operation method may include operation 340 of obtaining, or generating, a convolution operation result of the encrypted input data based on a rotation operation of an operation result set obtained corresponding to groups in the kernel set.

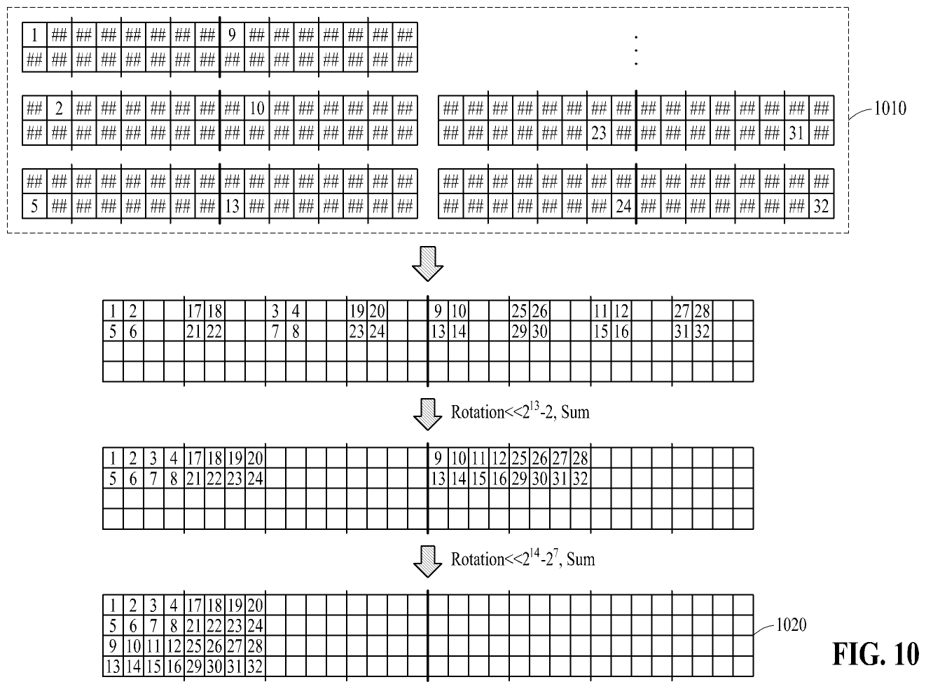

FIG. 10 illustrates an example operation of generating a convolution operation result according to one or more embodiments.

Referring to FIG. 10, in a non-limiting example, 16 operation result sets 1010 may be generated by performing a convolution operation on all kernels included in a kernel set. A rotation operation may be performed to combine the 16 operation result sets 1010 into one piece of data. The rotation operations may be performed twice to dispose the 16 operation result sets 1010 in final result data 1020 of the convolution operation.

Since an operation of a ciphertext does not change the length of the ciphertext, the size of the final result data 1020 may be the same as that of the entire packing data corresponding to a duplication constant of input data. In an example, when a convolution operation of stride 2 is performed on input data of a size of 32×32×16 and 32 kernels of a size of 3×3×16, the resulting data may correspond to a size of 16×16×32. When the duplication constant is 2, packing data of the input data may correspond to a size of 32×32×16×2=32,768. A convolution operation result corresponds to data of a size of 16×16×32=8,192, so the convolution operation result may correspond to a size of ¼ of the packing data of the input data. Since the operation of the ciphertext does not change the length of the ciphertext, the size of the final result data 1020 may be 32,768 and the convolution operation result of the size of 8,192 may be duplicated to preserve the density of data, so four identical duplicated operation results may be disposed in the final result data 1020. The number of pieces of the same resulting data to be disposed in the final result data 1020 may be determined based on the number of strides.

Referring back to FIG. 3, in operation 330, the obtaining of the operation result set may include selecting an operation of a hoisting operation and a rotation operation based on the number of pieces of data to be summed for the convolution operation and obtaining, or generating, the operation result set based on the selected operation.

In an example, the selecting of the hoisting operation and the rotation operation may include selecting the operation of the hoisting operation and the rotation operation based on the number of pieces of data to be summed for the convolution operation and based on a comparison result of an operation time of a predicted hoisting operation and an operation time of a predicted rotation operation.

Like the rotation operation, the hoisting operation may correspond to a method of performing an operation to combine n pieces of ciphertext data. The hoisting operation may correspond to an operation using the fact that there are two stages, a pre-comp stage or other operations, on the rotation operation of one ciphertext.

Assuming, in an example, that a ratio of time consumed to perform the pre-comp stage and other stages is 6:4, the operation time of the hoisting operation to combine n pieces of data may correspond to an operation time of 0.6+0.4×(n−1) times of the rotation operation. The number of times of the rotation operations required to combine n pieces of data may be log₂n times.

In an example, when n is 4 (i.e., n=4), the rotation operation may be performed log₂4=2 times to combine four pieces of ciphertext data. When the hoisting operation is used, pieces of ciphertext data may be combined in a time corresponding to 0.6+0.4×(4−1)=1.8 times of the rotation operation. Accordingly, when n is 4 (i.e., n=4), the operation time consumed to combine n pieces of data may be reduced using the hoisting operation instead of the rotation operation.

In an example, when n is 8 (i.e., n=8), in response to 0.6+0.4×(8−1)=3.4 times of the rotation operation time, the operation time of the hoisting operation may take more operation time than performing log₂8=3 times of the rotation operation. Accordingly, when n is 8 (i.e., n=8), the operation time consumed to combine n pieces of data may be reduced using the rotation operation instead of the hoisting operation.

When the ratio of the pre-comp stage and other stages is a:(1−a), an operation time S(N) consumed to combine n pieces of data may be generalized as shown in Equation 1 below.

$$S ( N ) = min [ {log}_{2} N , a + ( 1 - a ) * ( N - 1 ) , {min}_{m} \{ S ( m ) + S ( \frac{N}{m} ) \} ] \qquad Equation 1$$

In Equation 1, m denotes any natural number below N.

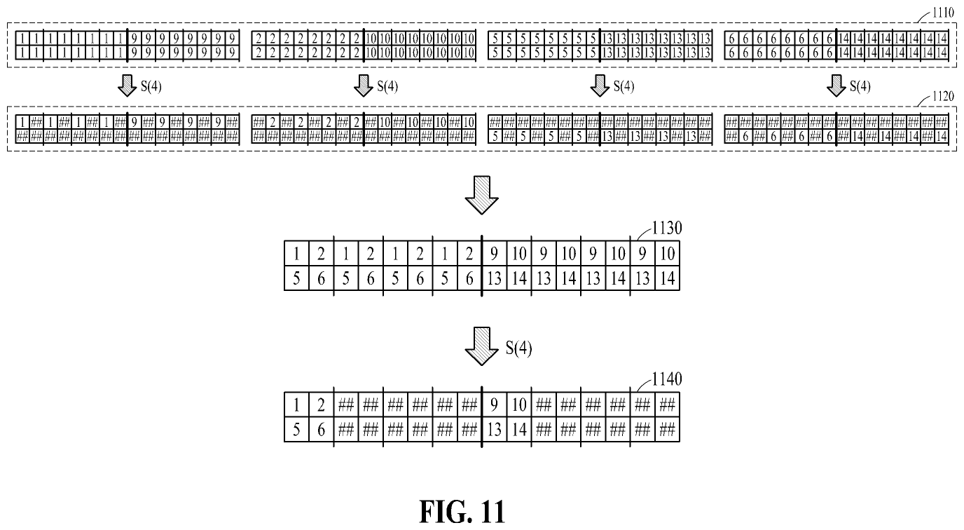

FIG. 11 illustrates an example homomorphic encryption operation process for generating a convolution operation result according to one or more embodiments.

Referring to FIG. 11, in a non-limiting example where, unlike the method described above with reference to FIGS. 7 to 10, an operation result set including a convolution operation result 1140 of eight kernels may be obtained.

As described above with reference to FIG. 7, elementwise product results 1110 of each of two kernels belonging to the same group and packing data may be obtained. To sum the elementwise product results 1110 corresponding to each channel for each kernel, a rotation operation and an addition operation may be performed on input data. Unlike the description provided above with reference to FIG. 8, intermediate operation result sets 1120 in which elementwise product results of each kernel corresponding to four channels are summed may be generated by performing the rotation operation and addition operation twice. An intermediate operation result included in the intermediate operation result sets 1120 may include a result generated by summing elementwise product results corresponding to two kernels belonging to the same group for each of four channels.

A convolution operation result 1140 corresponding to eight kernels may be generated by simultaneously performing the rotation operation and the addition operation on eight kernels (i.e., a first kernel, second kernel, fifth kernel, sixth kernel, ninth kernel, tenth kernel, thirteenth kernel, and fourteenth kernel) by combining the intermediate operation result sets 1120 into one piece of data 1130. Since the one piece of data 1130 generated by combining the intermediate operation result sets 1120 includes an operation result of four channels corresponding to each kernel, an operation time of S(4) may be consumed to obtain the convolution operation result 1140 by combining four pieces of data. The convolution operation result 1140 corresponding to eighth kernels may be generated through an operation corresponding to the operation time S(4). A convolution operation result corresponding to all kernels included in the kernel set may be generated by performing the same operation corresponding to other kernels.

Compared to the method described above with reference to FIGS. 3 to 10, the method described with reference to FIG. 11 may, in an example, reduce the number of rotation operations performed to generate the final convolution operation result by simultaneously performing the rotation operation on eight kernels instead of consuming more depth. The number of times that the multiplication operation may be performed on a ciphertext may be predetermined. The depth may correspond to the number of times the multiplication operation is performed. In an example, in FIG. 11, when the display ‘##’ indicating a meaningless value (or an invalid value) to combine the intermediate operation result sets 1120 is deleted, a depth may be consumed by 1. Compared to the method described above with reference to FIGS. 3 to 10, the method described with reference to FIG. 11 may consume more depth by 1 to delete the display ‘##’ in the process of combining pieces of data.

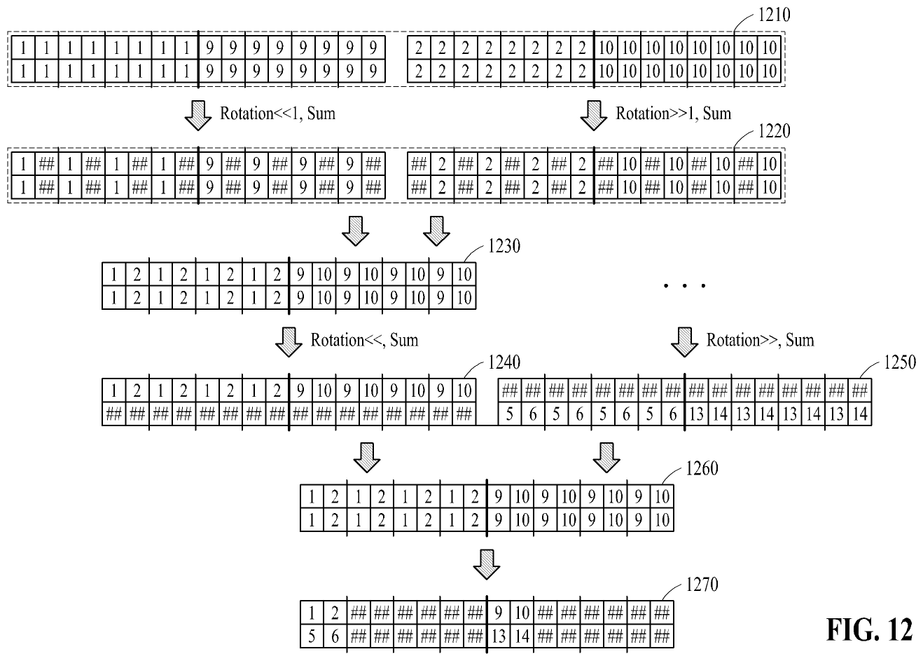

FIG. 12 illustrates an example homomorphic encryption operation process for generating a convolution operation result according to one or more embodiments.

Referring to FIG. 12, in a non-limiting example where unlike the method described above with reference to FIGS. 7 to 10, an operation result set including a convolution operation result 1270 of eight kernels may be obtained.

As described above with reference to FIG. 7, elementwise product results 1210 of each of two kernels belonging to the same group and packing data may be obtained. A rotation operation and an addition operation may be performed to sum the elementwise product results 1210 corresponding to each channel for each kernel. Unlike the description provided above with reference to FIG. 8, in an example, a first intermediate operation result set 1220 in which elementwise product results of each kernel corresponding to two channels are summed may be generated by performing the rotation operation and the addition operation one time. A result generating by summing two elementwise product results for each kernel may be obtained. A first intermediate operation result included in the first intermediate operation result set 1220 may include a result generated by summing elementwise product results corresponding to two kernels belonging to the same group for each of two channels.

A second intermediate operation result 1240 corresponding to four kernels may be generated by simultaneously performing the rotation operation and the addition operation on four kernels (i.e., a first kernel, second kernel, ninth kernel, and tenth kernel) by combining the first intermediate operation result set 1220 into one piece of data 1230. A convolution operation result 1270 corresponding to eight kernels may be generated by simultaneously performing the rotation operation and the addition operation twice on eight kernels (i.e., a first kernel, second kernel, fifth kernel, sixth kernel, ninth kernel, tenth kernel, thirteenth kernel, and fourteenth kernel) by combining the second intermediate operation result 1240 and the other second intermediate operation result 1250 into one piece of data 1260. Since the one piece of data 1260 generated by combining the second intermediate operation result 1240 and the other second intermediate operation result 1250 includes an operation result of four channels corresponding to each kernel, the operation time of S(4) may be consumed to generate the convolution operation result 1270 by combining four pieces of data. The convolution operation result 1270 corresponding to eighth kernels may be generated through an operation corresponding to the operation time S(4). A convolution operation result corresponding to all kernels included in the kernel set may be generated by performing the same operation corresponding to other kernels.

Compared to the method described above with reference to FIGS. 3 to 10, the method described with reference to FIG. 12 may, in an example, reduce the number of rotation operations performed to obtain the final convolution operation result by simultaneously performing the rotation operation on two kernels and simultaneously performing the rotation operation on four kernels instead of consuming more depth. Compared to the method described above with reference to FIG. 11, the method described with reference to FIG. 12 may consume more depth by 1 to delete the display ‘##’ in the process of combining pieces of data.

The neural networks, processors, memories, electronic apparatuses, electronic apparatus 10, receiver 100, processor 200, memory 300 described herein and disclosed herein described with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating packing data of encrypted input data, based on a packing constant and a duplication constant;
generating an operation result set based on a homomorphic encryption operation for a convolution operation on each of kernels belonging to a same group in the kernel set and the packing data; and
generating a convolution operation result of the encrypted input data based on a rotation operation of operation result sets generated corresponding to groups in the kernel set.

2. The method of claim 1, wherein the generating of the packing data of the encrypted input data comprises:
duplicating the encrypted input data according to the duplication constant; and
generating the packing data of the encrypted input data by arranging the duplicated encrypted input data for each channel based on the packing constant.

3. The method of claim 1, wherein an operation result set corresponding to one group in the kernel set is generated based on a rotation operation in a same rotation direction.

4. The method of claim 1, wherein the generating of the operation result set comprises:
generating an elementwise product result of each of the kernels belonging to a same group in the kernel set and the packing data;
performing a rotation operation and an addition operation on the elementwise product result; and
generating the operation result set by extracting a valid value from a result of the rotation operation and the addition operation.

5. The method of claim 4, wherein the generating of the operation result set further comprises:
generating, among the result of the rotation operation and the addition operation, the operation result set by multiplying the valid value by 0 and remaining values by 1.

6. The method of claim 1, wherein the kernels belonging to the same group in the kernel set are determined based on a disposition of the convolution operation result.

7. The method of claim 1, wherein the homomorphic encryption operation comprises a multiplication operation, an addition operation, and a rotation operation for the convolution operation.

8. The method of claim 1, wherein the generating of the operation result set comprises:
selecting an operation of a hoisting operation and a rotation operation based on a number of pieces of data to be summed for the convolution operation; and
generating the operation result set based on the selected operation.

9. The method of claim 8, wherein the selecting of the operation comprises selecting the operation of the hoisting operation and the rotation operation based on the number of pieces of data to be summed for the convolution operation and based on a comparison result of an operation time of a predicted hoisting operation and an operation time of a predicted rotation operation.

10. The method of claim 1, wherein the encrypted input data is configured to encode input data into a one-dimensional vector, and
wherein the encrypted input data is generated by encrypting the encoded one-dimensional vector.

11. A non-transitory computer-readable storage medium storing instructions that, when executed by a processor, cause the processor to perform the method of claim 1.

12. An electronic apparatus, the apparatus comprising:
a processor configured to:
generate packing data of encrypted input data, based on a packing constant and a duplication constant;
generate an operation result set based on a homomorphic encryption operation for a convolution operation on each of kernels belonging to a same group in a kernel set and the packing data; and
generate a convolution operation result of the encrypted input data based on a rotation operation of operation result sets generated corresponding to groups in the kernel set.

13. The apparatus of claim 12, wherein, in response to the generating of the packing data of the encrypted input data, the processor is configured to:
duplicate the encrypted input data according to the duplication constant; and
generate the packing data of the encrypted input data by arranging the duplicated encrypted input data for each channel based on the packing constant.

14. The apparatus of claim 12, wherein the processor is further configured to generate an operation result set corresponding to one group in the kernel set based on a rotation operation in a same rotation direction.

15. The apparatus of claim 12, wherein, in response to the generating of the operation result set, the processor is further configured to:
generate an elementwise product result of each of the kernels belonging to a same group in the kernel set and the packing data;
perform a rotation operation and an addition operation on the elementwise product result; and
generate the operation result set by extracting a valid value from a result of the rotation operation and the addition operation.

16. The apparatus of claim 15, wherein, in response to the generating of the operation result set, the processor is further configured to:
obtain, among the result of the rotation operation and the addition operation, the operation result set by multiplying the valid value by 0 and the remaining values by 1.

17. The apparatus of claim 12, wherein the processor is configured to determine kernels belonging to the same group in the kernel set based on a disposition of the convolution operation result.

18. The apparatus of claim 12, wherein the homomorphic encryption operation comprises a multiplication operation, an addition operation, and a rotation operation for the convolution operation.

19. The apparatus of claim 12, wherein, in response to the generating of the operation result set, the processor is further configured to:
select an operation of a hoisting operation and a rotation operation based on a number of pieces of data to be summed for the convolution operation; and
generate the operation result set based on the selected operation.

20. The apparatus of claim 19, wherein, in response to the selecting of the operation of the hoisting operation and the rotation operation, the processor is further configured to:
select the operation of the hoisting operation and the rotation operation based on the number of pieces of data to be summed for the convolution operation and based on a comparison result of an operation time of a predicted hoisting operation and an operation time of a predicted rotation operation.
